(19) United States
(12) Patent Application Publication
(10) Pub. No.: US 2014/0195444 A1
(43) Pub. Date: Jul. 10, 2014

(54) SYSTEM AND METHOD FOR ADVERTISING, AUCTIONING, RENTING OR SELLING RENTAL PROPERTIES AND/OR REAL ESTATE

(71) Applicant: SLATERN, INC., New York, NY (US)

(72) Inventor: Jeremy Bernard, New York, NY (US)

(21) Appl. No.: 14/152,062

(22) Filed: Jan. 10, 2014

Related U.S. Application Data
(60) Provisional application No. 61/750,994, filed on Jan. 10, 2013.

(51) Int. Cl. G06Q 50/16; G06Q 10/10

(52) U.S. Cl. CPC G06Q 50/163; G06Q 10/10
USPC 705/314

(57) ABSTRACT

A system is provided for the storage and exchange of contracts and payments for an item. The processor of the system is configured to receive at least one communication and to present it to each of the owners associated with at least two items in a manner such that each of the owners are informed of every other of the items included in at least one communication from a potential purchaser/renter/user. The processor is further configured to receive an acceptance from any of the owners associated with the at least two items from the communication from the user. Upon acceptance the processor is configured to conduct a financial transaction between the user and the owner and communicating the same to the user and the owner.

### RELATED APPLICATION

This application claims the benefit of priority from provisional patent application No. 61/750,994 filed on Jan. 10, 2013, the entirety of which is incorporated by reference,

### FIELD OF INVENTION

The present arrangement provides for a system and method for exchanging advertisements and bids for rental properties between renters/buyers and property owners. More particularly, the present arrangement provides a system and method to support a binding arrangement for renter/buyers to issue a request and for property owners to bid on such request.

### DESCRIPTION OF RELATED ART

Currently, the primary method for property owners seeking to rent one or more properties is to set up an advertisement or offer to rent one or more properties and then disseminate the advertisement through any one of several traditional avenues, including newspapers, brokers, and web-based advertising. Potential renters can then seek such properties and offer either the asking rent or make a lower counter offer as depicted in FIG. 1.

However, with this arrangement there is no clear indication to a property owner how a particular potential renter is interacting with other properties they are seeking making it difficult to negotiate with the potential renter. For example, a property owner may receive a request to rent one of their properties for 10% less than their asking price. However, in existing systems, this same property owner does not know if the same bidder is also making offers to other property owners in the same neighborhood and how much those offers are for, particularly relative to the asking prices of those other owners. This makes it difficult for the property owner who received the 10% lower request to determine the existing market for theirs and other properties in the same geographic vicinity.

### OBJECTS AND SUMMARY

The present arrangement is a unique and innovative “reverse-auction” arrangement, implemented for example through a website, where buyers can list their properties for rent as in the prior art systems. However, unlike the prior art, renters can select multiple properties, such as vacation or full time rentals, and issue a bid/price they want to pay (which may or may not be lower than the asking price) and then initiate a 24-hour binding reverse auction whereby the first of the several property owners that accepts the renter's offer ends the reverse auction and simultaneously accepts the contract as a binding rental contract.

In this context, the present arrangement acts as an intermediary in the otherwise fragmented real estate market for vacation and full time rentals by creating a live, real-time marketplace whereby multiple property owners selected by the renter (supply) compete for a fixed price set by the renter (demand). Such an overall dynamic is shown for example in FIG. 2. This platform serves to eliminate the current inefficiencies that exist in the $400 B domestic market for vacation and full time rentals and allows the natural forces of supply and demand to better and more effectively drive any given transaction (vs. brokers or one-on-one discussions between owners and renters).

Furthermore, the present arrangement may be implemented as part of a collaborative consumption movement in the hospitality market, and may be used in other similar transactions beyond rental properties that currently utilizes a broker or middleman, including, but not limited to, travel offers, real estate sales, ticket sales, car rentals, etc . . .

The present arrangement benefits consumers by shifting the leverage that currently favors property owners who often play one prospective renter against the other to that of a more level playing field between one renter and multiple property owners.

In addition, the present arrangement incorporates multiple social networking tools to make the experience more transparent, i.e., viewing property owners and prospective renters' profiles on Facebook™ and Linkedin™ or other similar social media services.

In one embodiment, the present arrangement may be implemented for free to post and search, and charges the property owner and renter a service fee (e.g. 3% and 6%, respectively) only on successfully consummated transactions. This is a savings for example to vacation property owners who currently pay broker commissions of 10% or, in some cases, monthly fees to post on various websites and to full time rental property owners who pay broker commissions of one or two month's rent (8% or 16%).

The present arrangement also contemplates providing a savings to renters who currently pay service fees up to 50% higher to rent vacation properties on other websites and, depending on the market, are required to pay broker commissions of one or two month's rent for full time rentals.

To this end the present arrangement provides for a system for the storage and exchange of contracts and payments for an item. The system includes an interface for receiving inputs from a plurality of owners, each including information about at least one item and proposed contracting price for the item. A first database stores the received inputs and a processor manages the first interface and the database and is configured to store the received inputs.

A graphic user interface module, coupled to the processor, presents a plurality of item listings based on at least a portion of the inputs from the owners, where the interface is configured to receive at least one communication from a user seeking to contract with at least two items. The communication includes a proposed contract price for the items, and at least enough financial data of the user to complete a financial transaction with the owners for the items.

The processor is configured to receive the at least one communication and to present it to each of the owners associated with the at least two items in a manner such that each of the owners are informed of every other of the items included in the at least one communication. The processor is further configured to receive an acceptance from any of the owners associated with the at least two items from the communication from the user. Upon acceptance the processor is configured to conduct a financial transaction between the user and the owner and communicating the same to the user and the owner.

### DESCRIPTION OF DRAWINGS

FIG. 1 is a rough schematic of the the prior art systems;

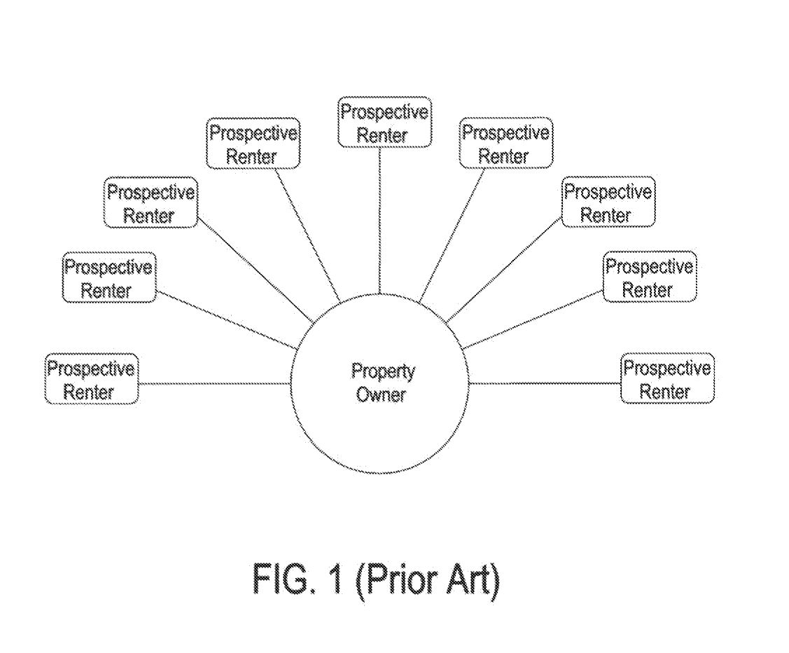

FIG. 2 is a rough schematic of the present invention, according to one embodiment;

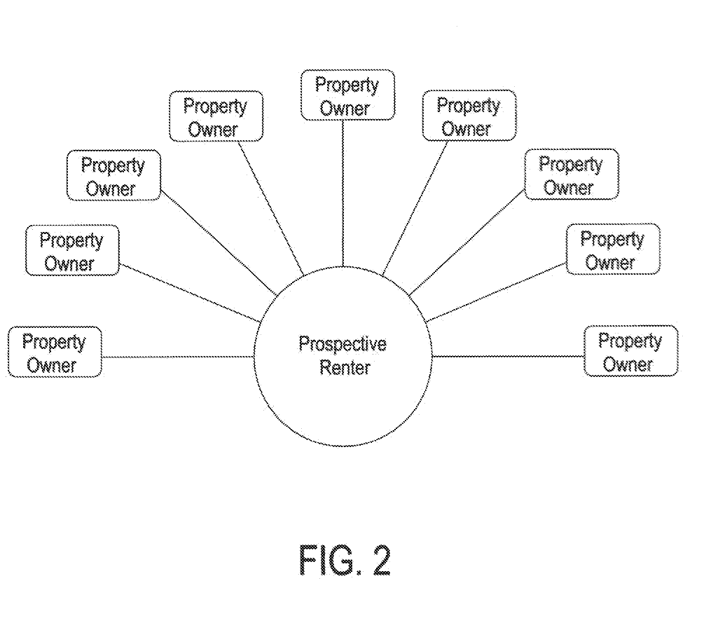

FIG. 3 is a system diagram, according to one embodiment;

FIG. 4 is a flow chart for owners, according to one embodiment;

FIG. 5 is a screen shot of the system, according to one embodiment;

FIG. 6 is a screen shot of the system, according to one embodiment;

FIG. 7 is a screen shot of the system, according to one embodiment;

FIG. 8 is a screen shot of the system, according to one embodiment;

FIG. 9 is a screen shot of the system, according to one embodiment;

FIG. 10 is a screen shot of the system, according to one embodiment; and

FIG. 11 is a flow chart depicting the method of the present invention according to one embodiment.

### DETAILED DESCRIPTION

The present arrangement provides a system and method for accepting, storing and presenting rental offers from a plurality of property owners and further allowing a renter to make a binding offer at their own price to one or more of the listed properties. Thereafter, the system and method supports displaying the offer to each of the property owners so that they not only know that they have received an offer, but the same offer has been extended to other properties, allowing the owners to gain a better perspective on the offer. Once an offer is accepted by one of the owners, assuming the offer does not expire for time, a binding contract is automatically generated between the owner and renter and the fees to renter and buyer are charged by the system.

For the purpose of illustrating each of the salient features of the present arrangement this application will be discussed in the context of vacation rentals and bids/offers between vacation home owners and prospective renters. However, this is intended only to be one example of the implementation of the invention and is not intended to be limiting. The features of the present invention may be equally applied to other situations, including but not limited to travel offers, real estate sales, ticket sales, car rentals, etc . . .

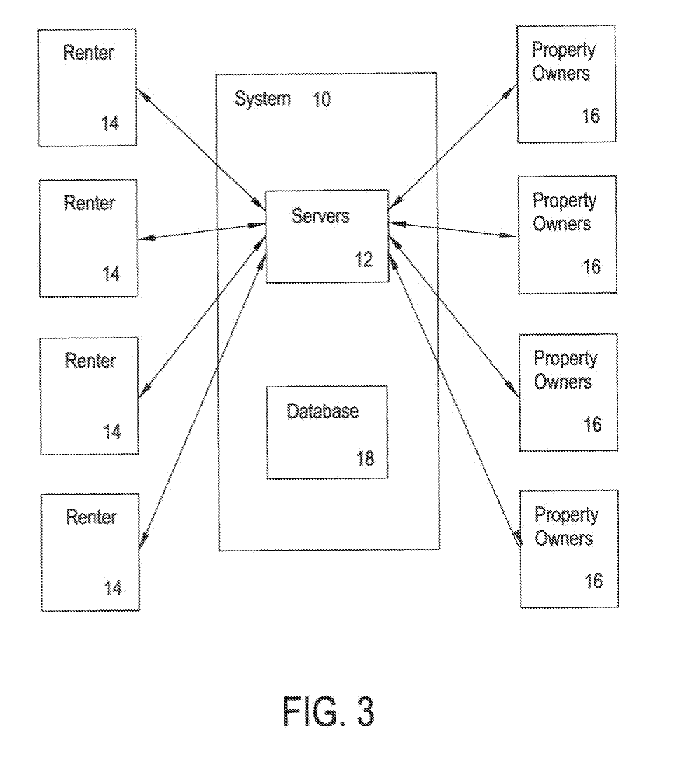

To this end, FIG. 3 shows a basic arrangement for the present system 10 having servers 12 for communicating with a plurality of renters 14 and property owners 16. Servers 12 of system 10 are coupled to database storage 18 configured to store the various data required for accepting and storing the property details for the rental properties. Database 18 and servers 12 are further configured to store the various software and user interface modules for allowing and facilitating the offer/acceptance and transaction protocols. It is noted that in one embodiment, renters 14 and owners 16 communicate with system 10 via a mobile application on a portable electronic device. Such mobile application may be generic to the system or different versions may be available for owners 16 versus renters 14.

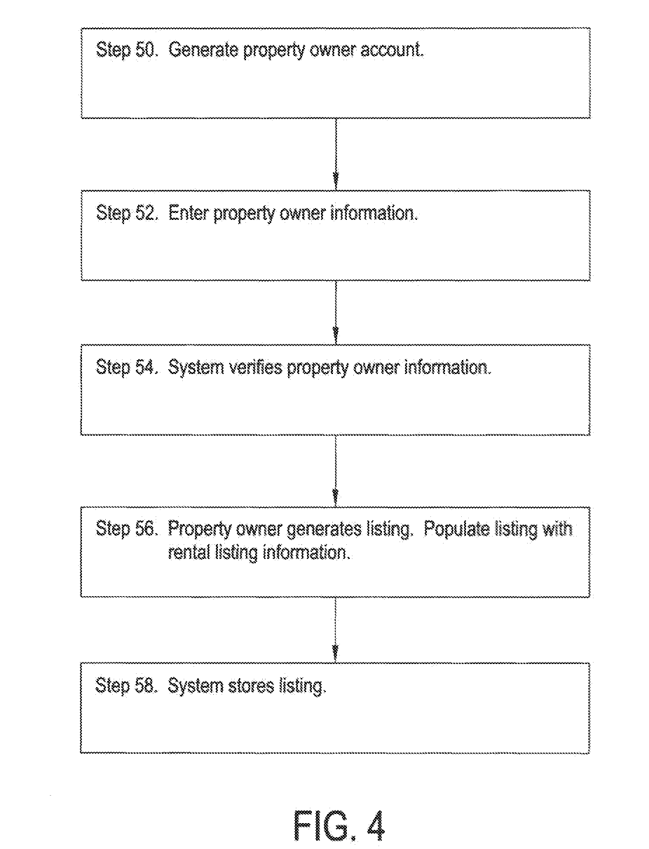

Turning to the implementation of the rental offer services and bid/completion process, FIG. 4 is a brief flow chart explaining the account set up and submission process for property owners 16. The following is a summary of one embodiment of the present arrangement.

In a first step 50, system 10 enables an interface to receive a request for an account set up for property owner 16. At step 52, property owner 16 enters various identification information to generate an account, including, but not limited to user name, password and other security and banking information required to complete the transaction discussed herein. An optional step 54 may includes system 10 performing verification on property owner to verify banking information and to prevent fraudulent accounts. Once an account is set up, property owner 16 may log out, However, assuming property owner 16 is likewise ready to list a rental property, at step 56 property owner 16 begins a new listing operation and provides system 10 with the relevant information for the listing. Such information may include but is not limited to, the name and location of the property listing (e.g. rental) the available times for rental, the cost for rental, the dates on which property owner 16 will offer such a deal, additional notes on the property, photographs, contact information for additional questions from prospective renters etc . . . . As noted above, the rental example is exemplary only and any addition steps or modification, such as for property sales, commercial properties, travel etc . . . may be included.

Once this information is saved, at step 58, the listing is generated in system 10 associated with property owner 16 and made available in the pool of listings according to its various searchable characteristics as discussed in more detail below. Other steps or information required to fulfill the requirements of the system may be added or supplemented as needed.

Turning to the renter side, the following description explains the process from a renter side, showing various screen shots for assisting in explaining the process. Such screen shots and descriptions of the renter bidding process are exemplary. It is understood, that different screen arrangements and other manners for progressing through the offer/acceptance processing are within the contemplation of the present invention.

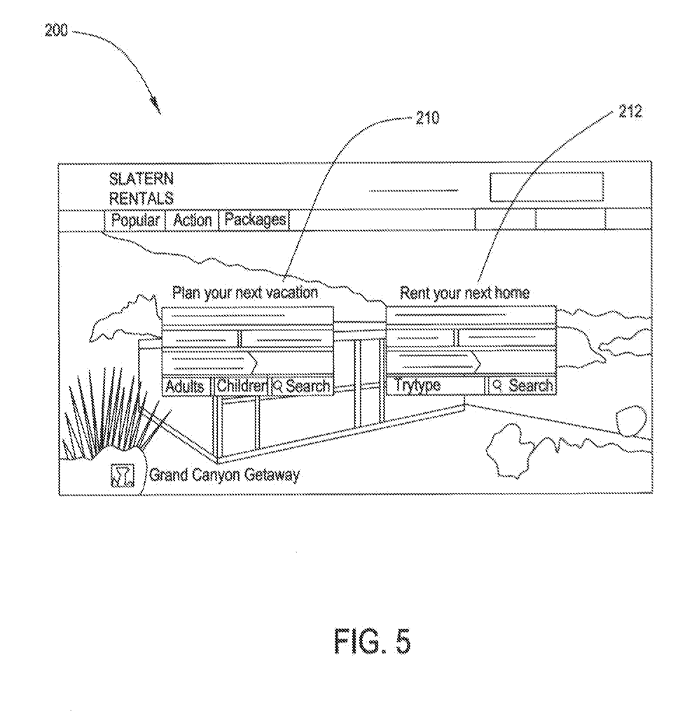

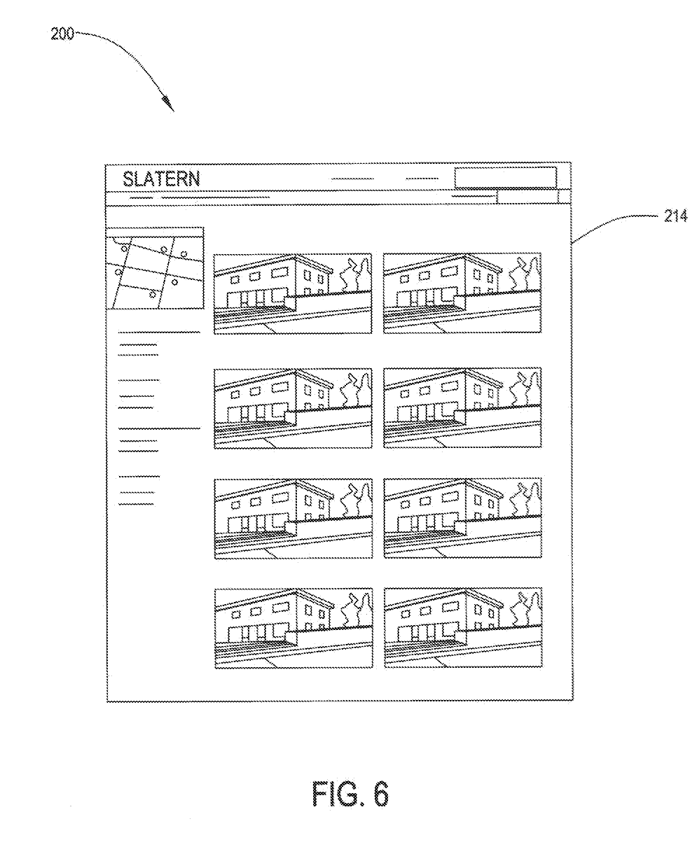

Upon arriving at a system 10 homepage 200, renters 14 can choose to either “Plan your next vacation” 210 or “Rent your next home” 212 as illustrated in screen shot FIG. 5. As shown in FIG. 6, in order to provide an example, of the function of system 10, the present description uses an assumption of a potential renter 14 looking to rent a vacation property from owners 16 in East Hampton, N.Y. from November 11^{th}-16^{th} and wants to pay $1,000/night. After entering that information on homepage 200 above, search results 214 appear as depicted in FIG. 6.

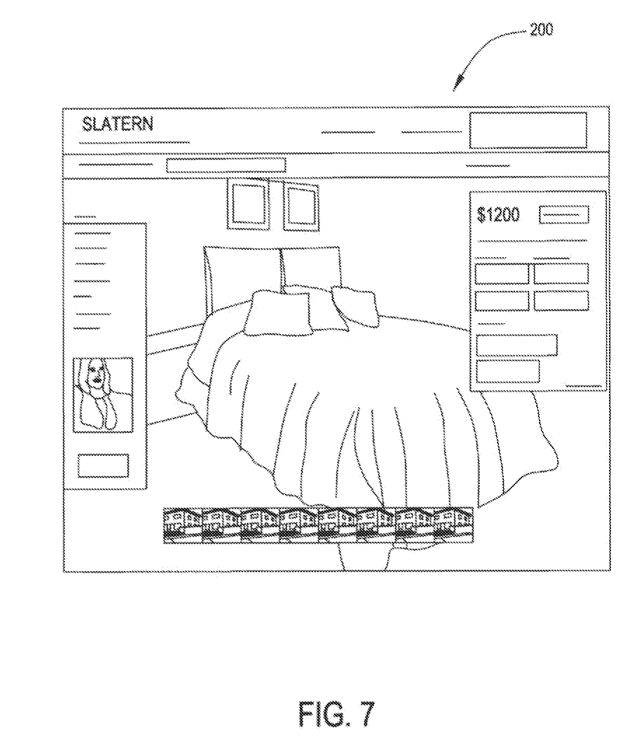

As shown in FIG. 7, renter 14 can click on any of the results properties to find out more details, view pictures, learn more about owner/host 16 (i.e. through their Facebook™ or Linkedin™ profile), read previous renter's reviews, etc . . .

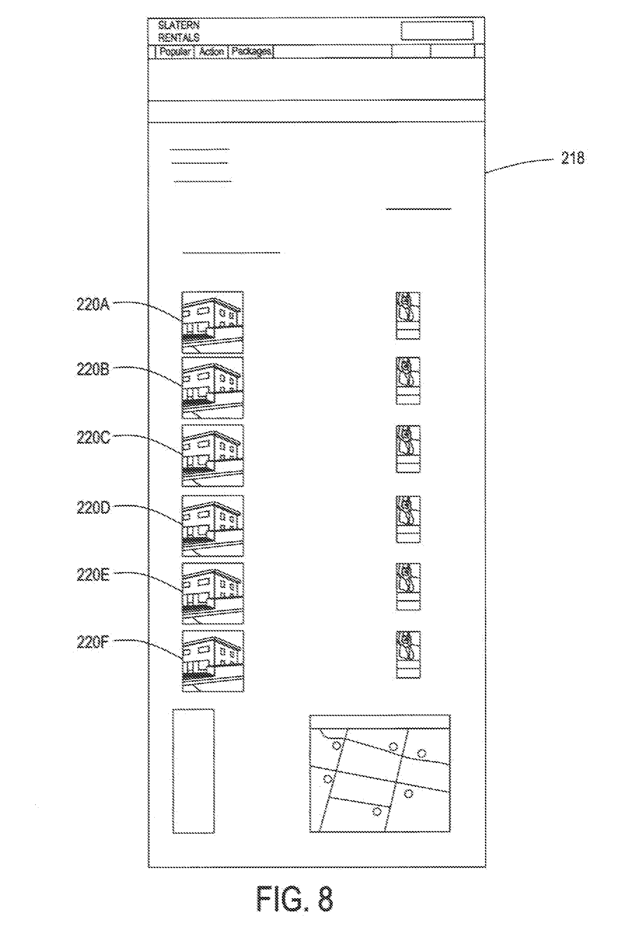

Next, the user can select from list 214, various properties from owners 16 to add to their auction/offer cart 218. As an example, referring to FIG. 8, renter 14 has added six (6) properties 220a-220f to cart 218, Prior to submitting a binding offer and initiating a reverse auction, potential renter 14 is able to review their ‘Auction Cart’ 218 and compare/contrast their selections.

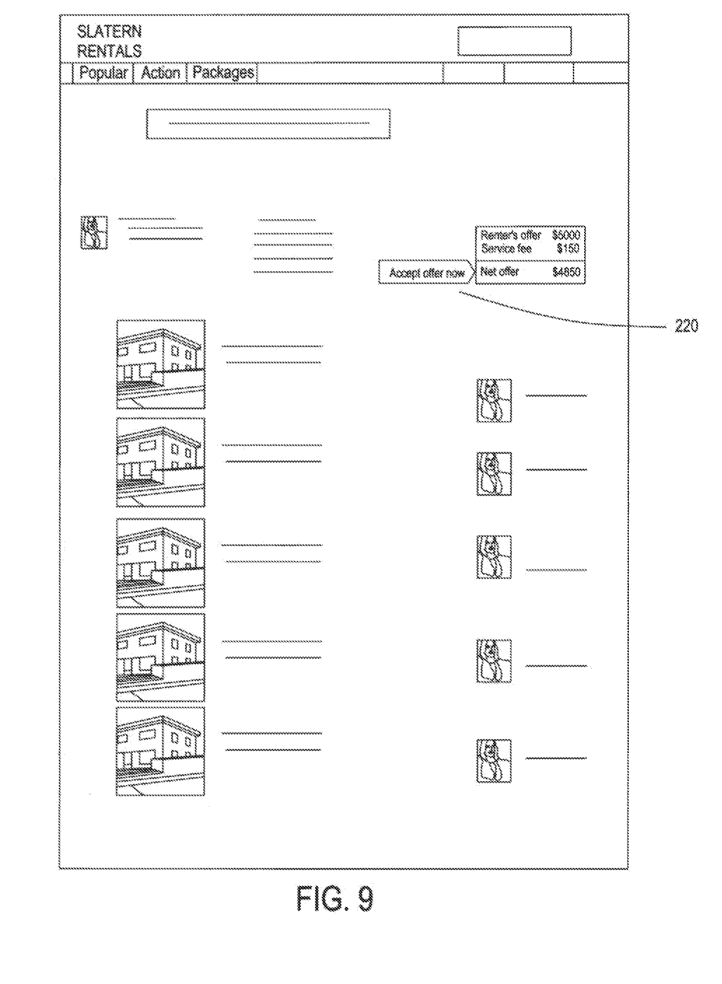

Referring to FIG. 9, after the renter engages the offer, such as a “Launch My Auction” icon, a 24-hour (or other set duration) live reverse auction begins whereby all property owners 16 from offer cart 218 are notified via email and system 10 mobile app that their property has been selected for a reverse auction and the binding offer from renter 14. The first property owner 16 to accept the offer, e.g. by hitting an “Accept offer now” tab 220 ends the reverse auction and closes/accepts the binding offer.

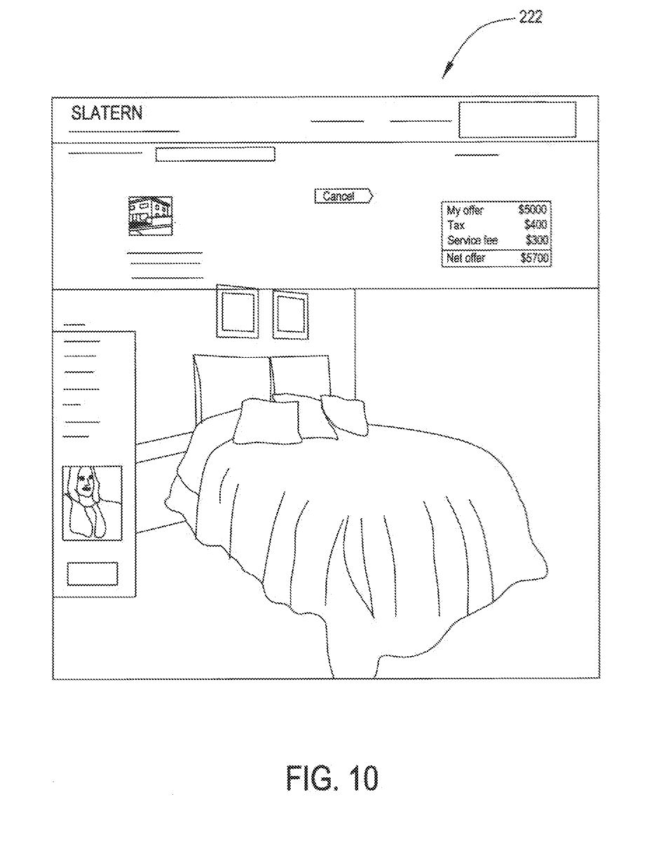

Upon the successful completion of the reverse auction, the credit card of renter 14 is debited and payment is made to property owner 16 less any service fees accepted by system 10. Renter's 14 and owner's 16 contact information is shared with each other through system 10 to arrange details of their trip. A closing page screen shot 222 is shown in FIG. 10.

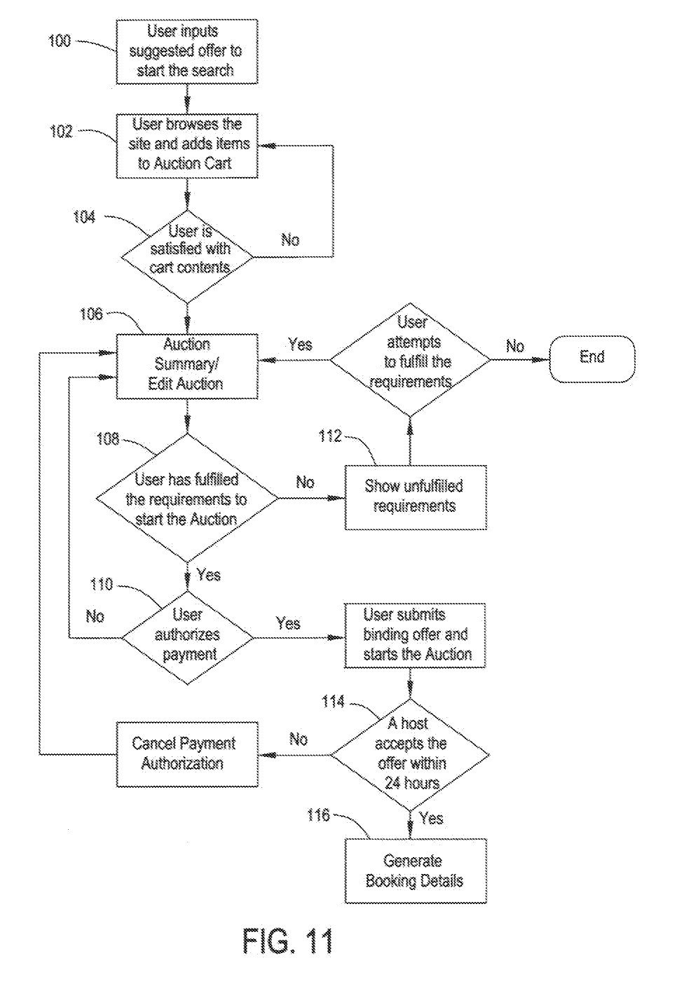

Further to the above summary and screen shot walk through of an auction via system 10, please see the following steps corresponding to the flow chart in FIG. 11. As an initial phase, renters 14 come to the home page and have a choice to either “Plan your next vacation” or “Rent your next home” as shown in FIG. 5. Similar to other prior art websites, renters 14 can search for properties by selecting various criteria, i.e., location, dates, # of guests, amenities, etc . . . using a detailed, customized searchable database. See e.g. FIG. 5-9.

At a first step 100, unlike other prior art websites, renters 14 enter the price they are willing to “offer” for either their vacation or full time rental. (E.g. only one offer per auction). See for example screen shot FIG. 9 and offer box 220. In step 102, renters 14 select as many properties that fit their criteria (regardless of the property owner's asking price) and add them to their “Auction Cart” 218.

Prior to initiating the reverse auction, renters 14 may be required to register at the web site which includes electronically signing either a pre-approved lease or vacation rental agreement in addition to providing credit card information to secure their offer.

At step 104-106 from FIG. 11, if renter 14 is satisfied with the cart contents, he receives an auction summary and can edit the auction if they desire. At steps 108-112, once renter 14 has fulfilled the requirements to start the auction, they authorize payment and submit a binding offer that starts the auction. After renter 14 hits a “Launch My Auction” icon, a 24-hour live reverse auction begins whereby all property owners 16 in auction bin 218 are notified (via email and the system's mobile app) that theft property has been selected for a reverse auction and of the binding offer of renter 14.

Property owners 16 are able to see all the other properties selected by renter 14 as part of the reverse auction, i.e., their “competition.” Property owners 16 are provided with a detailed profile of the prospective renter 14 and links to their Facebook™, Linkedin™ or other social media site accounts.

In step 114, the first property owner to hit the “Accept offer now” tab (see 220 in FIG. 9) ends the reverse auction. Upon the successful completion of the reverse auction, the credit card of renter 14 is debited. Vacation renters 14 are charged the full amount of their rental and full time renters 14 are charged two months rent in addition to a security deposit or some other agreed upon amount. In step 116, booking details may be generated to produce records of the transaction for renters 14, owners 16, and system 10.

After the rental or vacation or, otherwise after the term of the agreement, renters 14 are able to post reviews after their stay and rate their experience enabling property owners 16 to establish a social profile within system 10 itself. Similarly, property owners 16 are encouraged to post reviews of renters 14 enabling renters 14 to establish a positive social profile on system 10 potentially making it easier for them to secure accepted offers from other owners 16 in future transactions.

In addition to the above described features, additional features and embodiments may be applied to the structure and steps outlined above. For example, in a first embodiment, the present arrangement may offer renters 14 the ability to join the network whereby prospective renters 14 can partner with each other and jointly submit a binding offer for a property. This feature expands the universe of properties for renters 14 and tenants for property owners 16. For example, a vacation property owner 16 may be looking to rent their house only for the entire month of August and a renter 14 may only be interested in two weeks in August. By joining the present system 10, renter 14 can learn of other likeminded renters 14 looking to rent for two weeks in August and they may be able to jointly offer a price for the entire month of August (possibly with each renter 14 signing separate rental agreements and being responsible for their respective times spent in the house).

Similarly, if a renter 14 is looking to lease an apartment for six months and a landlord 16 is only willing to accept a one year lease, that renter 14 can identify another renter 14 looking to lease the apartment for the other six months. By renters 14 combining theft respective demand curves to accommodate certain restrictions on landlords 16 supply, the present system 10 can further enhance the overall efficiencies of the marketplace.

In another embodiment, prospective renters 14 who are interested in a particular house and believe it is fairly priced may be able to bypass the above described reverse auction process and offer owner 16 their asking price by clicking on an “Instant Booking” tab next to each property listing.

In other embodiments, system 10 may include a mobile application, where vacation renters 14 are able to take pictures and videos of their trip and by the evening of their check out date, they automatically receive a fully edited picture/video montage set to music in their inbox courtesy of the system 10.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A system for the storage and exchange of contracts and payments for an item, said system comprising:
an interface for receiving inputs from a plurality of owners, each of said inputs including information about at least one item and proposed contracting price for said item;
a first database for storing said received inputs;
a processor for managing said first interface and said database and configured to store said received inputs; and
a graphic user interface module, coupled to said processor, configured to present a plurality of item listings based on at least a portion of said inputs from said owners,
wherein said interface is configured to receive at least one communication from a user seeking to contract with at least two items, said communication including a proposed contract price for said items, and at least enough financial data of said user to complete a financial transaction with said owners for said items;
wherein said processor configured to receive said at least one communication and to present it to each of said owners associated with said at least two items, in a manner such that each of said owners are informed of every other of said items included in said at least one communication, and
wherein said processor is further configured to receive an acceptance from any of said owners associated with said at least two items from said communication from said user, wherein upon acceptance, said processor is configured to conduct a financial transaction between said user and said owner and communicating the same to said user and said owner.

2. The system as claimed in claim 1, wherein said items are selected from the group consisting of rental properties, travel offers, real estate sales, ticket sales and car rentals.

3. The system as claimed in claim 1, wherein said database, in addition to storing said inputs from said owners, said database is further configured to store user profiles and financial information for use in multiple or future transactions.

4. The system as claimed in claim 1, wherein each of said items includes at least one classification information about said property associated with said item so as to be searchable by said user.

5. The system as claimed in claim 4, wherein for any one presentation of said plurality of items to said user, each of said item listings includes a different proposed contracting contracting price.

6. The system as claimed in claim 5, wherein when said processor informs said owners of every other of said items included in said at least one communication, said processor informs said owners of said different proposed contracting contracting prices.

7. The system as claimed in claim 1, wherein said proposed contracting price included in said communication of said user is less than each of said proposed contracting prices for each of said items.

8. The system as claimed in dam 1, wherein said communication from said user including a proposed contracting price including a time frame upon which their proposed contract price may be automatically accepted in a binding manner.

9. The system as claimed in claim 8 wherein said financial transaction between said user and said owner is pre-approved by said system, where said proposed contracting price of said user is held by said system during said time frame.

10. The system as claimed in claim 1, wherein said system is configured to receive communications from said owners and said users via a mobile application.
